(19) United States
(12) Patent Application Publication
(10) Pub. No.: US 2010/0138160 A1
(43) Pub. Date: Jun. 3, 2010

(54) Model transition sensitivity analysis system and method

(76) Inventors: Geoffrey M. Jacquez, Ann Arbor, MI (US); James S. Koopman, Ann Arbor, MI (US); Stephen E. Chick, Fontainebleau (FR)

Correspondence Address: HOWARD & HOWARD ATTORNEYS PLLC, 450 West Fourth Street, Royal Oak, MI, 48067, US

(21) Appl. No.: 10/220,874

(22) PCT Filed: Mar. 29, 2001
(86) PCT No.: PCT/US01/10080

§ 371 Date: Oct. 25, 2007

(30) Foreign Application Priority Data
Mar. 29, 2000 (US) 60192818

(51) Int. Cl. G06F 19/00; G06Q 50/00

(52) U.S. Cl. 702/19; 705/2

(57) ABSTRACT

A method and system for analyzing an infectious disease uses computer based simulation engines. The method and system utilizes at least two computer-based simulation engines of the transmission of the infectious disease. The transmission of the infectious disease is analyzed as a function of the first and second computer-based simulation engines.

### BACKGROUND OF THE INVENTION

1. Field of the Invention

The present invention relates generally to infectious disease analysis, and more particularly, to a system and method for infectious disease model transition sensitivity analysis.

2. Description of the Prior Art

Effective infectious disease analysis, surveillance and control depend on informed decisions by public health authorities and infection control professionals. Because infection transmission systems are complex and non-linear, these professionals often rely on models to help them understand the complexities involved in their decisions. They use models to predict the course of epidemics, evaluate the efficacy of interventions, allocate resources efficiently, determine what drug and vaccine designs will be most effective, and in general assess how to best limit the spread of infectious diseases.

The goal of modeling is to formulate models that capture relevant aspects of system behavior while maintaining simplicity and ease of understanding. This is accomplished via abstraction and simplification.

Models are abstractions. Reality is highly complex and this complexity is made tractable by abstracting reality to represent important components within a mathematical form (the model type). Because they are abstractions, all models are “wrong” since they do not fully represent reality and thus cannot capture all behaviors of the modeled system. As abstractions, models are useful only when they capture aspects of a system's structure and behavior deemed relevant to a specific problem.

Models are simplifications. Simplification of complex reality is required in order to formulate understandable mathematical models. Hence there is a dynamic and a tension between simplification and the ability of models to adequately represent system behaviors.

Models rely on assumptions. Simplification is accomplished by making restrictive assumptions, and many such assumptions are intrinsic to model type. Thus one of the most important problems in modeling is to determine the sensitivity of model results and decisions based on those results to assumptions of model type and complexity. How can we determine whether an abstraction is appropriate, and how do we know when reality is oversimplified? These two issues underlie all mathematical models, and are the fundamental questions answered by MTSA.

When formulating models, critical choices are made regarding model type and complexity. Model type is the mathematical approach used to represent a system, for example, an ordinary differential equation model versus a discrete event model; or a deterministic model versus a stochastic model. Model complexity is determined by the amount of abstraction and simplification employed during model construction. A growing body of work demonstrates that choice of model type and complexity has substantial impacts on simulation results and on disease control decisions. Despite this, most analyses assess sensitivity only to a model's parameter values. Sensitivity to model type an complexity assumptions is difficult because of the lack of model transition sensitivity analysis (MTSA) software. This new term describes the analysis of how sensitive infection control decisions are to model type and complexity assumptions. In the absence of MTSA software it is almost impossible for decision makers to assess whether a proposed course of action is a good choice, or instead is highly sensitive to model type and complexity and is therefore an artifact of model selection. To support MTSA we need simulation tools that support a variety of model types, provide a common us interface, and that provide seamless transition from one form of model to another.

Infection transmission system models play an important role in the cost/benefit analysis of alternative approaches to reducing the risk of infection from an infectious disease such as Waterborne Cryptosporidia. Cryptosporidia is transmitted via animal reservoirs; within families, between unrelated individuals, are by ingestion of contaminated water. These different transmission modes can strongly influence the growth, behavior and dynamics of Cryptosporidia epidemics in human populations. The Environmental Protection Agency expends significant resources to reduce the risk of Cryptosporidia infection among the immuno-compromised. EPA Interventions are expensive and include installing an ozonation process at water plants and the installation of water filters in the homes of individuals at high risk of death from Cryptosporid infection. The failure to reach the correct decision thus involves enormous human as well as economic costs. Model Transition Sensitivity Analysis will substantially improve our ability to accurately decide whether water sanitation to control Cryptosporidia transmission should be directed at water treatment plants or at households of high-risk individuals such as those suffering from HIV infection.

Influenza immunization policy is founded on an understanding of influenza transmission systems. Current immunization efforts focus on high-risk individuals (e.g. the young, the elderly, al those prone to life-threatening pulmonary infections such as pneumonia). However, data on influenza transmission shows that transmission probabilities in families are considerably below the levels needs to sustain transmission in a population. What then accounts for epidemic spread? One hypothesis is that great variability contagiousness accounts for high transmission levels in settings like schools and low transmission settings like households. This strongly suggests that immunization strategy should focus on highly transmitting individuals to control the epidemic; as well as on high-risk individuals to reduce mortality. The design of studies to effectively evaluate alternative immunization policies is a difficult undertaking and requires Model Transition Sensitivity Analysis to assure the stability and accuracy the results.

Recent studies of HIV demonstrated a substantially increased probability of transmission between both homosexual and heterosexual partners when the infected partner was in the stage of primary viremia, and that this increased transmission probability is caused by elevated virus particle concentrations in the blood and semen. This observation suggests an intervention strategy that focuses on reducing serum virus particle concentrations during primary viremia. Model-based analyses demonstrate that such a strategy would be highly effective in controlling the HIV epidemic (Koopman, Jacquez et al. 1997). This strategy requires only a reduction in virus particle concentrations over the relatively brief stage of primary viremia in order to achieve a dramatic decrease in the total number of individuals infected over the course of the epidemic. Model Transition Sensitivity Analysis holds the promise of guiding drug and vaccine design decisions by more accurately evaluating the benefits and effectiveness of vaccination protocols in populations against the efficacy of drugs and vaccines in individuals.

The present invention is aimed at one or more of the problems as set forth above.

### SUMMARY OF THE INVENTION AND ADVANTAGES

In one aspect of the present invention, a method for analyzing an infectious disease using computer based simulation engines, is provided. The method included the steps of simulating transmission of the infectious disease using a first computer-based model and simulating the transmission of the infectious disease using a second computer-based model. The method further includes the steps of analyzing the transmission of the infectious disease as a function of the first and second computer-based simulation engines.

In another aspect of the present invention, a system for reviewing and analyzing transmission of an infectious disease, is provided. The system includes an input device for inputting data related to the infectious disease by a user and a visual display for displaying information to the user. The system further includes first and second computer-based simulation engines for modeling the transmission of the infectious disease.

The present invention is embodied in software tools for assessing the impacts of model assumptions on decisions regarding the analysis, surveillance, and control of infectious diseases. Most analyses consider sensitivity only to changes in a model's parameter values, and ignore how assumptions of model form (e.g. deterministic vs. stochastic, ODE vs. discrete individual) impact results and concomitant decisions.

The present invention enables analysis of sensitivity to model type and complexity, as well as to parameter values. Second, it will implement multiple, e.g., four, simulation engines in a common framework that empowers decision-makers to conduct model transition sensitivity analyses. Third, it will develop software that interfaces with a Geographic Information System (GIS) and spatial analysis tools that will make the handling of geographic and social dimensions tractable within infection transmission system analyses.

The present invention insures that unrealistic model assumptions don't lead to bad decisions. Model transition sensitivity analysis will greatly enhance our ability to make sound disease surveillance and control decisions by systematically relaxing the assumptions on which models are based. This project will put in place the methods and software to fully exploit this substantial opportunity.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is block diagram of a system for analyzing the transmission of an infectious disease, according to an embodiment of the present invention;

FIG. 2 is a flow diagram of a method for analyzing the transmission of an infectious disease, according to an embodiment of the present invention;

FIG. 3 is a block diagram of a class diagram according to an embodiment of the present invention;

FIG. 4 is a block diagram of a state diagram according to an embodiment of the present invention; and

FIG. 5 is a block diagram of a system for analyzing the transmission of an infectious disease, according to another embodiment of the present invention.

### DETAILED DESCRIPTION OF THE PREFERRED EMBODIMENT

With reference to the drawings an in operation, the present invention provides a system 100 and method 200 for review and analyzing transmission of an infectious disease is provided.

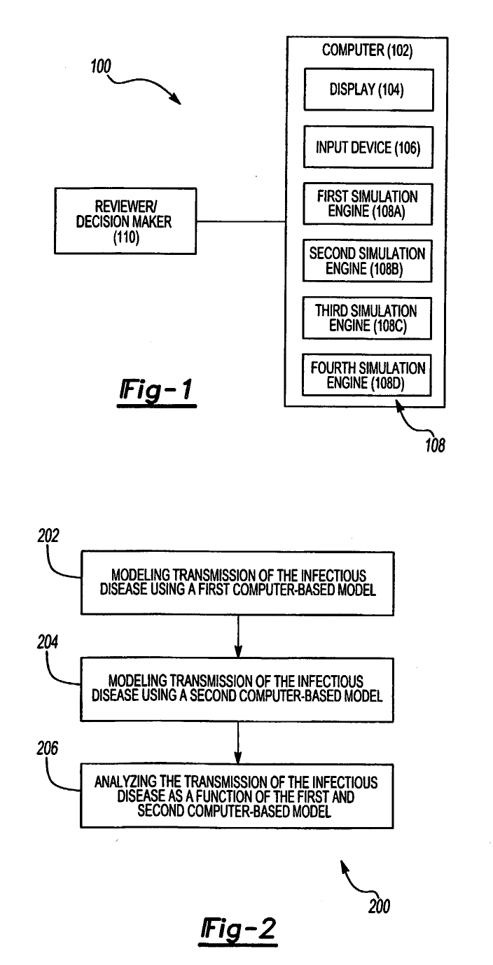

With specific reference to FIG. 1, the system 100 is preferably embodied in software running on a computer 102, e.g., a general purpose computer. The computer 102 includes a display 104, such as a cathode-ray tube (CRT) device or a flat panel display, and an input device 106, such as a keyboard, mouse, and/or microphone. The computer 102 has stored thereon at least two computer-based simulation engines 108 for modeling the transmission of the infectious disease, e.g., Cryptosporidia, influenza, or HIV. Preferably, the system 100 includes first, second, third, and fourth computer-based simulation engines 108A, 108B, 108C, 108D.

Data regarding the infectious disease is input by a user 110. The user 110 inputs parameters to the computer-based simulation engines and reviews the results displayed on the visual display 104. Preferably, the system 100 utilizes geographic information system (GIS) software to display, organize and assist in the analysis of the model results. Suitable GIS software is available from ESRI of Redlands, Calif. under the name “ArcView GIS”. The GIS software is adapted to combine the results of the first and second computer-based models and display information on the visual display to the user; to observe the transmission of the infectious disease; and to determine an impact of the computer-based simulation engines on the analysis of the transmission of the infectious disease. Based on the results displayed on the visual display 104, the user 110 is able to make decisions related to controlling the transmission of the infectious disease.

In the preferred embodiment, the computer-based simulation engines 108 are written in the C++ program language. The simulation engines are constructed using a common set of classes. This enables the system 100 to transition between the computer-based simulation engines 108 quickly and easily in order to facilitate analyzing the effect of the type and complexity of the engine has on decision made by the user 110.

The engines 108 are different in type and/or complexity. As discussed below in the preferred embodiment, the models are one of the following types:
a deterministic compartmental engine;
a deterministic ODE engine;
a stochastic discrete individual engine in continuous time without retention of individual histories; and
a stochastic engine with retention of individual histories.

For example, of the system 100 includes four computer-based simulation engines. Each engine is one of the types identified above and may differ by type and/or complexity.

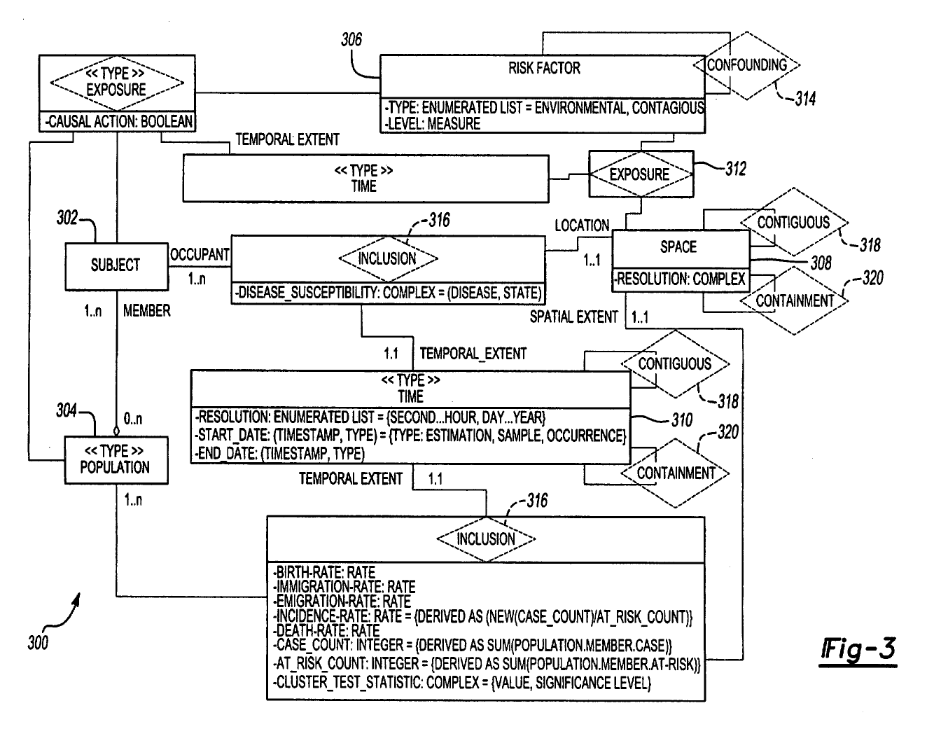

With specific, reference to FIG. 2, a method 200 for analyzing an infectious disease using computer based engine simulations is provided. The method includes the steps of :
simulating transmission of the infectious disease using a first computer-based simulation engine (first process step 202);
simulating the transmission of the infectious disease using a second computer-based simulation engines (second process step 204); and,
analyzing the transmission of the infectious disease as a function of the first and second computer-based simulation engines (third process step 206).

Specific requirements are formulated for the simulation engines and for components of the model complexity to be transited by the software. These requirements will determine:
simulation engines for modeling infection transmission systems;
spatial methods for identifying geographic subpopulations for modeling purposes; components of model complexity that can be relaxed across simulation engines; and,
functionality of the system 100, including visualization techniques, and the user interface.

Infectious disease models and simulation approaches for discrete and stochastic methods, as implemented in ODE and individual-level models, are well developed and are expected to carry over with little modification into the new MTSA software.

Other features may be incorporated into the simulation engines with substantial benefits in disease control, including:
Incorporate spatial and social dimensions
GIS interface and multivariate spatial analysis methods of identifying geographic subpopulations
Relax model type and complexity assumptions
Common framework for transiting across simulation engines.

Geography enters into infectious disease processed in several ways. First, individuals, groups and populations have geographic locations and spatial extent, and these may be static or change through time. Second, contact networks have geographic projections defined by the locations where infection events take place and by the spatial paths traveled by the infectious agent. The importance of geography varies from system to system. Water-borne diseases such as Cryptosporidia have transmission modes mediated by water flow. In these instances the map of the water distribution system is critical to our understanding of disease spread. In some diseases social and behavioral factors are important determinants of disease transmission, and the ma of the contact network has both social and spatial dimensions. Preferably, one or more of the simulation engines 108 include: (1) the representation and identification of individuals and populations in geographic space, and (2) the representation of contact networks as maps incorporating both spatial and social dimensions.

Preferably, one or more of the simulation engines 108 will also include:
Spatially agglomerative clustering: statistical methods and software for identifying geographic subpopulations based on multivariate characteristics including ethnicity, socioeconomic status, and race. The technique of spatially agglomerative clustering is particularly well suited to the identification of groups and populations for incorporation into infection transmission models.
Space-time information systems: a space-time data model that provides building blocks for constructing object models customized for specific applications. The space-time data model is implemented at two levels: the data structure level and the application level. Objects defined at the data structure level are the foundation upon which application-specific objects are built.

This model extends the diad (what, where) used in conventional GIS to the triad (what, where, when necessary for infectious disease modeling. Object identifies the modeled entity (i.e. a person or population); space-time coordinate is a spatio-temporal location (e.g. Latitude, Longitude Altitude, Date); and attributes are observations on variables describing the modeled entity and it environment (e.g. disease status, socioeconomic status or SES, exposed, vaccinated, etc.). The attributes are defined at the application level (see below) by extending the object definitions provided by the MTSA programming tool. This provides a powerful mechanism for designing custom objects that retain full functionality provided by the MTSA foundation library.

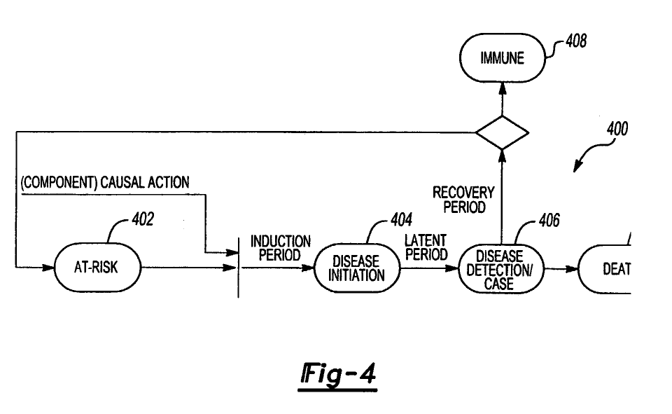

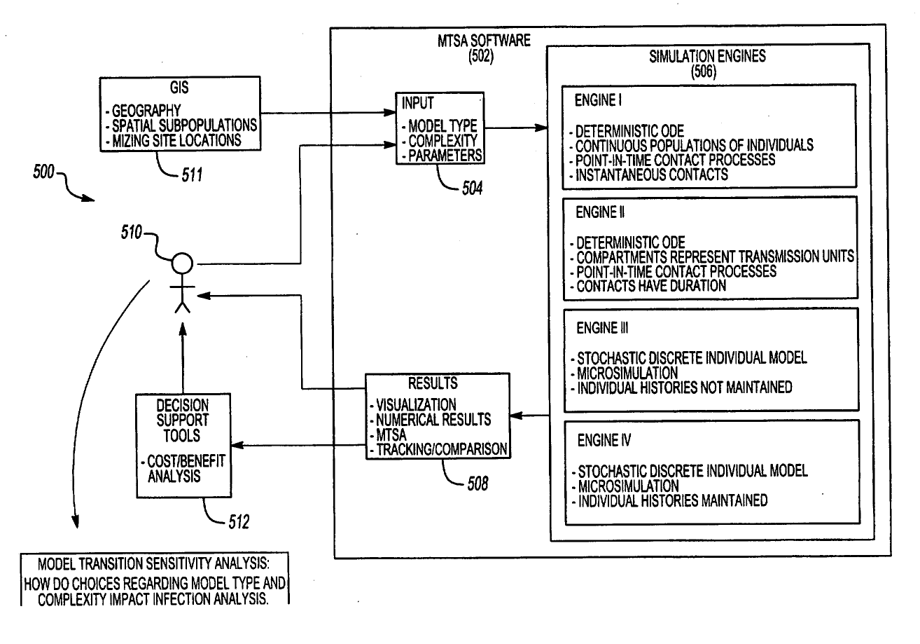

With reference to FIGS. 3 and 4, class diagrams 300 and state diagrams 400 are used to represent higher-level perspectives at the application level.

During implementation, classes in the Class Diagram 300 are constructed from object represented at the data structure level. Hence, State and Class Diagrams 300, 400 are typically application specific. The diagrams in FIGS. 3 and 4 have been designed for an infectious disease, but are generally enough to represent chronic disease as well. The State Diagram 400 represents a subject's disease susceptibility with the five states ‘at-risk’ 402, disease initiation’ 404, ‘disease detection’ 406, ‘immunity’ 408, and ‘death’ 410. These states are attributes of the object used to model subjects.

The class diagram shows the objects ‘subject’ 302 and ‘population’ 304, and the classes ‘risk factor’ 306, ‘space’ 308, and ‘time’ 310. Class and object relationships are shown as diamonds and include ‘exposure’ 312, ‘confounding’ 314, ‘inclusion’ 316, ‘contiguous’ 318 and ‘containment’ 320. Lines indicate logical connections and class relationships (the relationship exposure’ and the class ‘Time’ appear twice to avoid crossing lines).

This class diagram 300 was constructed using the Unified Modeling Language. For example, a Population is comprised of n subjects, and is indicated by the ‘1 to many’ relationship. The attribute birth rate, immigration rate, emigration rate and so on are related both to a Population, a Time (duration) and a geographic Space (spatial extent). This class diagram is the basis of the system 100 object model, and has several advantages:
It records information on individuals and populations through time, enabling the tracking a individual history and model results.
It indexes spatial and temporal location, tracking information required to make geographic maps of contact networks and disease maps.
It handles spatial, temporal and social dimensions necessary for transmission system modeling.
It is general and flexible, and uses inheritance to reduce overhead at the application level.

A link to GIS software provides a seamless mechanism for integrating the software into spatial decision support systems. This is accomplished using common GIS file formats and through an ArcView link. This leverages ArcView's relational data base management (RDBM) capabilities an provides a mechanism (the common link to ArcView) for exchanging data with existing spatial analysis software. The link to ArcView will be accomplished as an ArcView extension. Extensions are a convenient way to add functionality to ArcView. Extensions add new buttons and menu choices to ArcView, and allow it to display, utilize and prepare additional data formats. The extension will be created as an Avenue script that is then saved as an extension. This extension will add an ‘MTSA’ speed button to ArcView. Clicking on this button allows the user to define data sets, variables and fields to share with our software (e.g. establish a database connection), and to then run MTSA.

The key to model transition sensitivity analysis is the ability to relax model complexity assumptions while transiting across simulation engines.

Four simulation engines types have been identified which represent the range of model types and complexity used t model infectious disease transmission systems.
Engine I: Deterministic compartmental models formulated as ODEs where each compartment represents a fraction of a population. These assume point-time contacts in large, thoroughly mixed populations.
Engine II: Deterministic ODE models with compartments representing transmission units like sexual couples or families as well as individuals. This relaxes the assumption in the previous engine that contacts have no duration.
Engine III: Stochastic discrete individual models in continuous time without retention of individual histories. Stochasticity can be simulated in either individuals or populations depending on which unit maximizes computational efficiency while preserving simulation faithfulness to model assumptions Unlike forms I and II, this engine can capture stochastic effects attributable to small mixing units.
Engine IV: Stochastic models with retention of individual histories. The retention of past history by individual agents facilitates thorough exploration of model behavior, and allows past events to influence current behavioral tendencies as represented by model parameters.

With reference to FIG. 5, a system 500 for analyzing the transmission of an infectious disease embodied in a model transition sensitivity system (MTSA) software application 502. The MTSA software application 502 is indicated by the large box “MTSA software” and is comprised of modules for preparing input 504, conducting simulations 506, and for handling results 508. A decision maker 510 is represented by the stick figure to the left of the MTSA software box 502. Input on model type and complexity is provided by the decision maker 510 and by an external Geographic Information System 512 that defines geography, spatial sub-populations, and mixing sites. Results are passed to the decision maker 510 as graphics and tabular numerical results comparing and contrasting how changes in model type and complexity impact model outputs. These results may also be imported to external decision support tools 512 (e.g. spreadsheets) for cost/benefit analysis. The decision maker 510 evaluates assumptions regarding model type and complexity by determining how these assumptions impact model outputs and the decisions drawn from those outputs, resulting in a model transition sensitivity analysis.

MTSA software 502 includes the ability to traverse models of varying complexity. They almost certainly include the four structural components models of disease progression, models of the force of infection, sub-populations, and mixing.

Models of Disease Progression: A basic structural component is a model or models of disease progression. “Model or models” is used because the model of disease progression may differ for some subgroups. This is important because we need to model the stages of development of the disease in individuals that influence transmission. Thus the infectivity of infecteds generally changes as a disease progresses. In addition, contact rates are important for transmission and may change as an illness progresses. A model of disease progression is needed for each population subgroup.

Models of the Force of Infection: For each model of disease progression, we need a model of the force of infection. This requires that we define the contact rates of different subgroups, the mixing between them and the probability of transmission per contact for the different subgroups. That in effect gives model of transmission of the disease to incorporate in the model of disease progression for each subgroup.

Subpopulations: Real populations are not homogeneous and the members of different subgroups do n mix randomly with all other individuals. Thus a population has in it subgroups that differ in ethnicity, religion and socio-economic status and these differences influence the rates of transmission of diseases. Two major ways are, the extent of mixing between subgroups as compared with within subgroup mixing, and the probability of transmission per contact may differ because of particular group practices or customs, for example, in food preparation. Population subgroups can also be define by geographic location and such subgroups intersect with subgroups defined by socio-economic and ethnic status. Furthermore, the subgroups relevant for transmission of one disease may differ from those important in the transmission of a different disease. Consequently, one has to examine the issue of definition of important subgroups for each particular disease.

One of the more difficult problems in modeling transmission of diseases is to model to mixing processes that lead to disease-transmitting contacts between individuals. The most commonly used assumption is that individuals make contacts at random with others in the population. In terms of contacts between subgroups that is commonly called proportional mixing. There are a number of other more complicated ways to model mixing that allow for the possibility of varying within group contact rates as compared with contact rates with other groups. Two of the most versatile are called preferred mixing and structured mixing. In preferred mixing, one can reserve an arbitrary fraction of a group contacts for within-group mixing; all non-reserved contacts are then subject to proportional mixing. Structured mixing takes into account that most contacts occur in or are initiated in particular gathering places or activities. An arbitrary fraction of a group's contacts is allocated to each activity; the mixing at each activity is then assumed to be a proportional mixing.

These complexity components are preferably formalized within a unifying object model that constitutes the framework for transiting from one simulation engine to another. This abstraction is designed specifically for translating model inputs to meet the specific input requirements of each simulation engine, and provides paths for navigating between the simulation engines in order to relax complexity assumptions. This object model will be constructed using Object-Oriented Analysis and Design (OOA&D). OOA&D is a relatively new technique that achieve unprecedented programming efficiency. The era of monolithic ‘spaghetti code’, inherently difficult to maintain, translate and program, is coming to an end. The simulation engines 108 are constructed using classes whose relationships define the system architecture. The object design is critical to project execution, because it directly impacts the long-term sustainability of the end product and because an efficient and clear design dramatically streamlines all programming tasks

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

1. A method for analyzing an infectious disease using computer based simulation engines, including the steps of:
simulating transmission of the infectious disease using a first computer-based simulation engine;
simulating the transmission of the infectious disease using a second computer-based simulation engine; and,
analyzing the transmission of the infectious disease as a function of the first and second computer-based simulation engines.

2. A method, as set forth in claim 1, wherein the step of analyzing transmission of the infectious disease includes the step of observing the transmission of the infectious disease.

3. A method, as set forth in claim 1, including the step of observing the transmission of the infectious disease using geographic information system software.

4. A method, as set forth in claim 1, including the step of determining an impact of the computer-based simulation engines on the analysis of the transmission of the infectious disease.

5. A method, as set forth in claim 1, including the step of making decisions related to controlling the transmission of the infectious disease.

6. A method, as set forth in claim 1, wherein the first and second computer-based simulation engines use a common set of foundation classes.

7. A method, as set forth in claim 1, including the step of transitioning between the first and second computer-based simulation engines.

8. A method, as set forth in claim 1, wherein the first computer-based simulation engine is one of a deterministic compartmental engine, a deterministic ODE engine, a stochastic discrete individual engine in continuous time without retention of individual histories, and a stochastic engine with retention of individual histories.

9. A method, as set forth in claim 8, wherein the second computer-based engine is one of a deterministic compartmental engine, a deterministic ODE engine, a stochastic discrete individual engine in continuous time without retention of individual histories, and stochastic engine with retention of individual histories.

10. A method, as set forth in claim 1, wherein the first and second computer-based simulation engines include a model of disease progression.

11. A method, as set forth in claim 1, wherein the first and second computer-based simulation engines include a model of infection force.

12. A method, as set forth in claim 1, wherein the first and second computer-based simulation engines include a model of sub-populations.

13. A method, as set forth in claim 1, wherein the first and second computer-based simulation engines include a model of mixing.

14. A method, as set forth in claim 1, including the step of transiting between the first and second simulation engines using a common framework.

15. A method for analyzing an infectious disease using computer based simulation engines, including the steps of:
simulating transmission of the infectious disease using a deterministic compartmental engine;
simulating the transmission of the infectious disease using a deterministic ODE engine;
simulating transmission of the infectious disease using a stochastic discrete individual engine in continuous time without retention of individual histories;
simulating the transmission of the infectious disease using a stochastic engine with retention of individual histories; and,
analyzing the transmission of the infectious disease as a function of the simulation engines.

16. A method for analyzing an infectious disease using computer based simulation engines, including the steps of:
simulating transmission of the infectious disease using a first computer-based simulation engine;
simulating the transmission of the infectious disease using a second computer-based simulation engine, wherein the first and second simulation engines include a model of infection force, a model of sub-populations, and a model of mixing;
transiting between the first and second simulation engines using a common framework; and,
analyzing the transmission of the infectious disease as a function of the first and second computer-based simulation engines.

17. A system for reviewing and analyzing transmission of an infectious disease, comprising:
an input device for inputting data related to the infectious disease by a user;
a first computer-base simulation engine of the infectious disease for simulating transmission of the infectious disease as a function of the data input by the user;
a second computer-based simulation engine of the infectious disease coupled to the first computer-based simulation engine for simulating transmission of the infectious disease; and,
a visual display coupled to the first and second computer-based simulation engines for displaying results of the first and second computer-based simulation engines to the user.

18. A system, as set forth in claim 17, wherein the system includes geographic information system software which is adapted to combine the results of the first and second computer-based simulation engines and display information on the visual display to the user.

19. A system, as set forth in claim 18, wherein the geographic information system is used to observe the transmission of the infectious disease.

20. A system, as set forth in claim 18, wherein the geographic information system is used to determine an impact of the computer-based simulation engines on the analysis of the transmission of the infectious disease.

21. A system, as set forth in claim 17, wherein the system is used to make decisions related to controlling the transmission of the infectious disease.

22. A system, as set forth in claim 17, wherein the first and second computer-based simulation engines use a common set of classes.

23. A system, as set forth in claim 17, wherein the system is adapted to transition between the first and second computer-based simulation engines.

24. A system, as set forth in claim 17, wherein the first computer-based simulation engine is one of a deterministic compartmental engine, a deterministic ODE engine, a stochastic discrete individual engine in continuous time without retention of individual histories, and a stochastic engine with retention of individual histories.

25. A system, as set forth in claim 24, wherein the second computer-based engine is one of a deterministic compartmental engine, a deterministic OCE engine, a stochastic discrete individual engine in continuous time without retention of individual histories, and a stochastic engine with retention of individual histories.

26. A system, as set forth in claim 17, wherein the first and second computer-based simulation engines include a model of infection force.

27. A system, as set forth in claim 17, wherein the first and second computer-based simulation engines include a model of sub-populations.

28. A system, as set forth in claim 17, wherein the first and second computer-based simulation engines include a model of mixing.

29. A system, as set forth in claim 17, including means for transiting between the first and second simulation engines using a common framework.

30. A system for reviewing and analyzing transmission of an infectious disease, comprising:
an input device for inputting data related to the infectious disease by a user;
a deterministic compartmental engine of the infectious disease for simulating transmission of the infectious disease as a function of the data input by the user;
a deterministic OCE engine of the infectious disease for simulating transmission of the infectious disease as a function of the data input by the user;
a stochastic discrete individual engine in continuous time without retention of individual histories of the infectious disease for simulating transmission of the infectious disease as a function of the data input by the user;
a stochastic engine with retention of individual histories for simulating transmission of the infectious disease as a function of the data input by the user; and,
a visual display coupled to the first and second computer-based simulation engines for displaying results of the first and second computer-based simulation engines to the user.

31. A system for reviewing and analyzing transmission of an infectious disease, comprising:
an input device for inputting data related to the infectious disease by a user;
a first computer-based simulation engine of the infectious disease for simulating transmission of the infectious disease as a function of the data input by the user;
a second computer-based simulation engine of the infectious disease coupled to the first computer-based simulation engine for simulating transmission of the infectious disease, wherein the first and second simulation engines include a model of infection force, a model of sub-populations, and a model of mixing;
means for transiting between the first and second simulation engines using a common framework; and,
a visual display coupled to the first and second computer-based simulation engines for displaying results of the first and second computer-based simulation engines to the user.

32. A system, as set forth in claim 17, wherein the first and second computer-based simulation engines include a model of disease progression.
